(19) United States
(12) Patent Application Publication
(10) Pub. No.: US 2026/0079071 A1
(43) Pub. Date: Mar. 19, 2026

(54) LEAK TESTING DEVICE WITH LEAK DETECTION SYSTEM

(71) Applicant: AVL DiTest GmbH, Graz (AT)

(72) Inventors: Dietmar Muchitsch, Graz (AT); Benjamin Ivantsits, Graz (AT); Julian Ritsch, Graz (AT); Nicola Szuecs, Graz (AT)

(21) Appl. No.: 19/322,133

(22) Filed: Sep. 8, 2025

(30) Foreign Application Priority Data
Sep. 10, 2024 (AT) A50735/2024

(51) Int. Cl. G01M 3/28

(52) U.S. Cl. CPC G01M 3/2815

(57) ABSTRACT

In order to improve the checking of test volumes of components, in particular vehicle components, with a leak testing device and to simplify the process and application of the leak test and the leak detection, the leak testing device comprises a housing which has at least one test inlet, at least one test outlet and an aerosol outlet, wherein at least the following are arranged in the housing: a pneumatic unit which is connected to the at least one test inlet and the at least one test outlet, a control unit which is designed to control the pneumatic unit in order to change a pressure of a medium present at the at least one test inlet to a predetermined first pressure during operation of the leak testing device and to provide and monitor the medium with the first pressure at the test outlet for checking a component connected to the test outlet for leak-tightness, and an aerosol generator which is designed to generate aerosol, wherein the aerosol generator is connected to the pneumatic unit and the aerosol generator is connected to the aerosol outlet, wherein, for leak detection, the pneumatic unit is designed to direct the medium with the first pressure into the aerosol generator in order to convey the aerosol generated in the aerosol generator into a component connected to the aerosol outlet of the housing.

### TECHNICAL FIELD OF THE INVENTION

The present invention relates to a leak testing device for checking components, in particular vehicle components, for leak-tightness and for leak detection.

### PRIOR ART

When repairing vehicle components, such as a battery or a coolant circuit, or after the repair has been completed, the vehicle components are checked for leaks. For example, when repairing a battery (for example, a lithium-ion traction battery), the battery housing is opened. After the repair has been completed, the battery is closed and sealed again. Subsequently, or prior to reinstalling the battery, the leak-tightness of the battery housing must be verified, as described for example in US 2022/0410717 A1.

This is usually carried out by checking for an acceptable pressure drop (or increase). For this purpose, a volume of the vehicle component to be tested, such as the battery housing, is pressurized and then sealed. The pressure drop in this volume is then measured over a certain period of time and compared with a specified limit value. Based on this comparison, the leak-tightness of the vehicle component is determined.

An alternative method is to bring the test volume of the vehicle component to a defined pressure level and keep said pressure level constant. The pressure is built up by a pump, and a valve regulates the volume flow. The volume flow is measured and thus allows conclusions to be drawn about the leak-tightness of the vehicle component.

If a leak in the vehicle component is detected by the leak test, smoke is introduced into the volume of the vehicle components to be tested, as disclosed in U.S. Pat. No. 9,417,152 B2, for example, in order to locally determine or locate the location of the leak by observing where the smoke escapes from the volume. For this purpose, a separate smoke generator is used in which oil is first vaporized in an oil container and the resulting smoke is introduced into the volume to be tested. The oil container of the smoke generator is regulated to a temperature between 70° C. and 95° C.

Particularly due to the rapid rise in battery-powered vehicles, which are increasingly appearing on the used-vehicle market and requiring maintenance, leak testing of battery housings is of great importance. However, using two separate devices is time-consuming, as it requires connecting each device to the component to be checked and then testing and evaluating it. The separate devices also increase the risk of incorrect use of the respective device by a user.

### SUMMARY OF THE INVENTION

It is therefore an object of the present invention to improve the checking of test volumes of components, in particular vehicle components, and to simplify the process and application of leak testing and leak detection.

According to the invention, the object is achieved in that the leak testing device comprises a housing which has at least one test inlet, at least one test outlet, and an aerosol outlet, wherein at least the following are arranged in the housing: a pneumatic unit which is connected to the at least one test inlet and the at least one test outlet, a control unit which is designed to control the pneumatic unit in order to change a pressure of a medium present at the at least one test inlet to a predetermined first pressure during operation of the leak testing device and to provide and monitor the medium with the first pressure at the test outlet for testing a component connected to the test outlet for leak-tightness, and an aerosol generator which is designed to generate aerosol, wherein the aerosol generator is connected to the pneumatic unit and the aerosol generator is connected to the aerosol outlet, wherein, for leak detection, the pneumatic unit is designed to direct the medium with the first pressure into the aerosol generator in order to convey the aerosol generated in the aerosol generator into a component connected to the aerosol outlet of the housing. By combining the pneumatic unit and the aerosol generator in a common housing with a control unit, separate devices are no longer necessary and the leak test and the leak detection can be carried out with a single device. In particular, this reduces the time required to test and evaluate the component to be checked for leak-tightness.

In a preferred embodiment, the leak testing device comprises a switch unit, which is provided to connect the pneumatic unit to the aerosol generator or to the test outlet. This creates a pneumatic separation so that no liquids and/or aerosols can enter each other's path, but still only one pneumatic unit can be used in the leak testing device.

Preferably, the first pressure is an underpressure or an overpressure. This allows the connected component to be tested in different ways, increasing the flexibility in the application of the leak testing device.

In an advantageous embodiment, the housing has a further test outlet which is connected to the pneumatic unit, wherein the pneumatic unit is designed to change the pressure of the medium present at the test inlet to a second pressure different from the predetermined first pressure and to provide the medium with the second pressure at the further test outlet. This makes it possible to test different components with the leak testing device. For example, testing a coolant circuit requires a higher pressure (range) than testing a battery housing. The two test outlets are preferably pneumatically separated so that no liquids and/or aerosols can enter each other's path. However, only one pneumatic unit can be used in the leak testing device.

Preferably, the housing has an air inlet and an air outlet in order to direct air heated by the generation of the aerosol during operation of the leak testing device in the vicinity of the aerosol generator through the air outlet out of the housing and to direct ambient air through the air inlet into the housing, wherein a passive cooling of the housing takes place by convection. The electrical and/or electronic components of the leak testing device used for the leak test are heat sensitive. This is remarkable given that the pneumatic unit and aerosol generator are combined in a common housing with the control unit, because, in particular with pressure sensors, deviations (drift) in the measured values occur when they are heated to an inadmissible level or are exposed to temperature fluctuations. Passive cooling provides a simple way to protect the components in the housing of the leak testing device, in particular the control unit and sensors, from the heated air in the vicinity of the aerosol generator. This ensures the functionality of the (temperature-sensitive) components for leak testing, which increases the reliability and measurement accuracy of the leak test.

Preferably, the aerosol generator is at least partially encased in a thermally insulating material. The insulation of the aerosol generator also makes it possible to protect the electrical and/or electronic components in the housing of the leak testing device from the heat of the aerosol generator, which increases the reliability and measurement accuracy of the leak test.

In a preferred embodiment, the housing is divided by a partition wall into a pneumatic area and an aerosol generator area, wherein the pneumatic unit is arranged in the pneumatic area and the aerosol generator is arranged in the aerosol generator area, and the pneumatic area is connected to the aerosol generator area via a channel. This also enables a (thermal) separation of the aerosol generator from the electrical and/or electronic components for leak testing in the pneumatic area, for example, pressure sensor, control unit, etc. The channel allows cooler air to be directed from the pneumatic area into the aerosol generator area during convection in the housing.

In addition, a side of the partition wall facing the aerosol generator preferably has a thermally insulating material. The insulation of the partition wall also makes it possible in a simple manner to protect the electrical and/or electronic components in the pneumatic area from the heat of the aerosol generator.

In a further preferred embodiment, the leak testing device has at least one safety valve which is designed to regulate the pressure of the medium to a predetermined safety pressure. The safety valve makes it possible to reliably regulate the leak testing device to a safe pressure level even in the event of a power supply failure or a failure of the control unit, in particular, in order to prevent an impermissibly high pressure in the housing.

Preferably, a connecting hose is provided which is connected to one of the test outlets of the housing and defines a predetermined test volume in order to calibrate the leak testing device. This makes it possible in a simple manner to calibrate or check the leak testing device without the need for an additional test volume, for example, a component, since the connecting hose can be used for this purpose.

In an advantageous embodiment, the housing further comprises a starting material inlet which is connected to the aerosol generator in order to provide a starting material for generating the aerosol. Alternatively, a starting material container is preferably arranged in the housing and is connected to the aerosol generator in order to provide a starting material for generating the aerosol. This allows the starting material for generating the aerosol to be provided in different ways, which increases the flexibility of the leak testing device.

### DESCRIPTION OF THE FIGURES

The present invention is described in greater detail below with reference to FIGS. 1 to 3, which, by way of example, show advantageous embodiments of the invention in a schematic and non-limiting manner. In the figures:

FIG. 1 shows the basic structure of the leak testing device according to the invention,

FIG. 2 shows an advantageous embodiment of the leak testing device according to the invention, and

FIG. 3 shows an air flow through the housing interior of the leak testing device in a side sectional view.

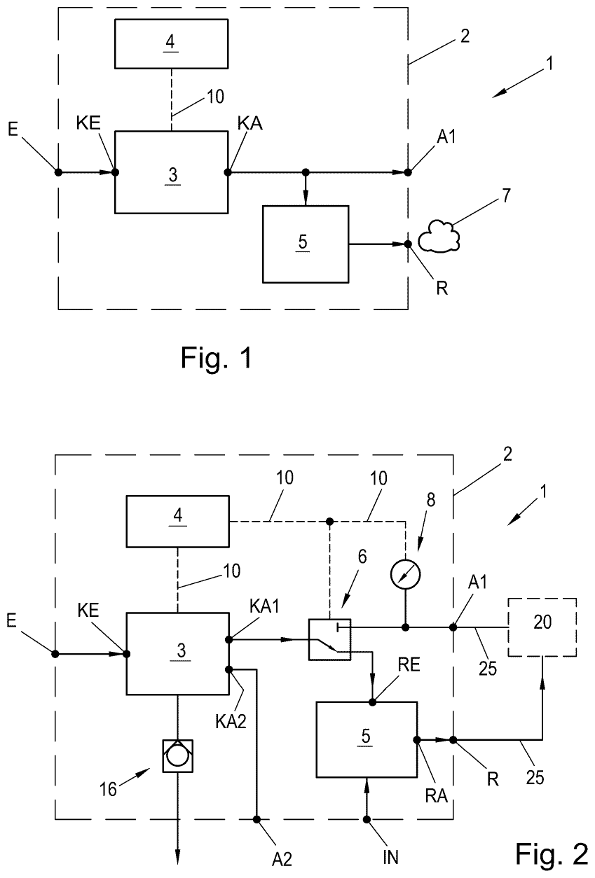

In FIG. 1, the basic components of the leak testing device 1 according to the invention are shown only schematically. The leak testing device 1 is used to check components 20, in particular vehicle components, for leak-tightness and for leak detection. Vehicle components to be checked can be, for example, a battery, a cooling circuit, etc. The application of the leak testing device 1 is, of course, not limited to components 20 of vehicles, such as motor vehicles, aircraft, ships, etc. In general, the leak testing device 1 is suitable for test volumes of components 20 which are to be tested for leak-tightness. Test volumes of components 20 such as pressure vessels (for example, in the pharmaceutical or chemical industry), heaters, pipelines, door seals, etc., can also be checked with the leak testing device 1 according to the invention.

The leak testing device 1 comprises a housing 2. The housing 2 is preferably designed as a type of case (e.g. a hard-shell case). The case consists of two case halves, for example, which can be closed together. The housing 2 preferably has a carrying element, for example, a handle, a tab, etc., so that a user can easily transport the leak testing device 1. Alternatively, the housing 2 of the leak testing device 1 can also be designed as a control cabinet for use on a test bench, for example. The housing 2 is, of course, not limited to the embodiments mentioned.

According to the invention, the housing 2 of the leak testing device 1 has a test inlet E, a test outlet A1, and an aerosol outlet R. The outlets and inlets A1, R, E of the housing 2 are designed as pneumatic connections, for example. Connecting hoses 25 can be connected to the test inlet E, the test outlet A1, and the aerosol outlet R, for example, via a quick-coupling connection. The connecting hoses 25 are designed to be used for checking the leak-tightness and for leak detection and to be connected to the test volume of the component 20 to be tested, as shown by way of example in FIG. 2.

A pneumatic unit 3 is arranged in the housing 2. The pneumatic unit 3 is connected to the test inlet E and the test outlet A1. As shown in FIG. 2, the test inlet E is connected to a pneumatic inlet KE of the pneumatic unit 3. The test outlet A1 is connected to a pneumatic outlet KA of the pneumatic unit 3. Alternatively, in a simple manner, the pneumatic inlet KE can form the test inlet E of the housing 2 and the pneumatic outlet KA can form the test outlet A1 of the housing 2.

The term “connected” means that the pneumatic unit 3 is connected to the test inlet E and the test outlet A1 in such a way as to convey a medium (e.g. a fluid connection via a pneumatic line). Fluid connections (pneumatic or hydraulic) of the components of the leak testing device 1 are shown in FIGS. 1 and 2 as solid lines. Components such as filters, chokes, etc., can be provided along the connections. In addition, the terms “pneumatic inlet” and “pneumatic outlet” are not to be interpreted in a restrictive manner, e.g. to a pneumatic connection, but merely serve as a designation for the connections of the pneumatic unit 3.

The pneumatic unit 3 is designed to change a medium present at the test inlet E to a predetermined first pressure and to provide the medium with the first pressure at the test outlet A1. In FIG. 1, the path of the medium from the test inlet E, through the pneumatic unit 3 and to the test outlet A1 is shown by means of arrows. For example, ambient air, nitrogen, forming gas, helium, etc. can be used as the medium.

The pneumatic unit 3 preferably comprises a compressor and/or an expander to change the medium from an inlet pressure at the test inlet E to the predetermined first pressure (e.g. between 0 and 4 bar relative to the environment of the leak testing device 1). Alternatively, multiple compressors can also be provided as compressor stages and/or multiple expanders as expander stages in order to change the medium gradually to the first pressure. The first pressure depends substantially on the component 20 to be checked. Depending on the application of the leak testing device 1, the pneumatic unit 3 is designed to provide the medium with a underpressure or an overpressure at the test outlet A1 for leak testing of the connected components 20.

In this context, the term “change” means to compress or relax (expand) the medium to a specified pressure at the test outlet. For example, depending on the inlet pressure of the medium and the required pressure at the test outlet, the pneumatic unit 3 is designed to compress or relax the medium.

As shown in FIG. 2, the housing 2 preferably has a further test outlet A2 which is connected to the pneumatic unit 3. The further test outlet A2 can be designed identically to the existing test outlet A1. The pneumatic unit 3 is designed to change the medium present at the test inlet E to a second pressure different from the predetermined first pressure (e.g. between 0 and 150 mbar relative to the environment of the leak testing device 1) and to provide the medium with the second pressure at the further test outlet A2. The pneumatic unit 3 is designed to change the medium to both the first pressure and the second pressure. For example, two compressors may be provided in the pneumatic unit 3, wherein one of the two compressors is designed to compress the medium to the first pressure and the other of the two compressors is designed to compress the medium to the second pressure. Analogously, two expanders can also be provided to relax the medium to the first or second pressure.

Preferably, the pneumatic unit 3 comprises a valve unit which is designed to switch between the two test outlets A1, A2. Alternatively, the housing 2 can also have a further test inlet (not shown), which is connected to the pneumatic unit 3. The further test inlet can be designed identically to the existing test inlet E. The pneumatic unit 3 can be designed to change a medium at the test inlet E to the first pressure and to change a medium at the further test inlet to the second pressure.

A control unit 4 is arranged in the housing 2, which is designed to control the pneumatic unit 3 in order to change the medium present at the test inlet E to the predetermined first pressure and to provide and monitor the medium with the first pressure at the test outlet A1 for checking a component 20 connected to the test outlet A1 for leak-tightness. In the event that the further test outlet A2 is provided, the control unit 4 is designed to control the pneumatic unit 3 in order to change the medium present at the test inlet E to the predetermined second pressure and to provide and monitor the medium with the second pressure at the further test outlet A2 for checking a component 20 connected to the further test outlet A2 for leak-tightness. The control unit 4 is preferably a microprocessor-based hardware unit, for example, a microcontroller. The control unit 4 is connected to the pneumatic unit 3 via a suitable wired or wireless connection in order to control it. In FIGS. 1 and 2, a wired connection 10 (e.g. an electrical line) is shown as a dashed line.

The control unit 4 also preferably comprises at least one pressure sensor 8 in order to monitor the medium with the first pressure at the test outlet A1 for checking the component 20 connected to the test outlet A1 for leak-tightness. The at least one pressure sensor 8 is designed to measure the pressure of the medium. For this purpose, the pressure sensor 8 is connected, for example, with the connection between pneumatic outlet KA and test outlet A1 (as shown in FIG. 2). The pressure sensor 8 can be connected to the control unit 4 via a suitable wired or wireless connection. In FIG. 2, a wired connection 10 (e.g. an electrical line) is shown by way of example as a dashed line. The pressure sensor 8 is shown in FIG. 2 as external to the control unit 4, although it can also be provided within the control unit 4. Of course, a pressure sensor 8 can also be provided in the same way for the further test outlet A2 in order to measure the pressure of the medium at the further test outlet A2. Preferably, a pressure sensor 8 is also provided, which measures the inlet pressure of the medium present at the test inlet E. In addition, a pressure sensor 8 can be provided in the leak testing device 1, which measures an ambient pressure of the leak testing device 1. For the sake of simplicity, only one pressure sensor 8 is shown in FIG. 2.

The measured pressure of the medium can be used by the control unit 4 to control the pneumatic unit 3 during operation of the leak testing device 1. To check the leak-tightness of the component 20 to be tested, the measured pressure of the medium can be evaluated in order to determine a pressure drop in the test volume of the connected component 20 over a defined period of time and to compare it with a specified limit value. For this purpose, the control unit 4 preferably comprises an evaluation unit (not shown). The evaluation unit is preferably integrated into the control unit 4. The evaluation unit can be implemented as microprocessor-based hardware, for example, as a microcontroller.

Alternatively, the control unit 4 can control the pneumatic unit 3 to bring the test volume of the connected component 20 to a defined pressure (e.g. the first pressure) and to keep it constant. A volume flow of the medium into the test volume of the connected component 20 is measured, and the evaluation unit assesses the leak-tightness of the connected component 20 based thereon. For this purpose, the control unit 4 comprises, for example, a flow meter (not shown) which is designed to measure the volume flow of the medium into the test volume of the connected component 20.

A suitable algorithm can be stored in the control unit 4, which algorithm is designed to execute an automated test program for checking the leak-tightness of the connected components 20 according to any of the methods mentioned.

In addition, the leak testing device 1 can comprise an operating unit via which a user can operate the leak testing device 1 (e.g. to start the test program). As the operating unit, buttons, a touchscreen, or similar can be provided with which the user can control the leak testing device 1. To display a result from the test of the leak-tightness, the leak testing device 1 may comprise a display unit (for example, a screen). In addition to a visual display, the result can also be communicated to the user acoustically. The operating unit and the display unit are preferably comprised in the housing 2.

Furthermore, an aerosol generator 5 is arranged in the housing 2, which is designed to generate aerosol 7. In FIG. 1, the aerosol 7 is only indicated schematically. The aerosol 7 can be generated by various methods using the aerosol generator 5. Preferably, the aerosol 7 is produced by heating and vaporizing a starting material, e.g. oil. For this purpose, the aerosol generator 5 comprises a container in which the starting material is heated, for example, with a heating coil. The container is heated to approximately 70-95° C. This heats up the area surrounding the aerosol generator 5 in the housing 2.

The housing 2 may also have a starting material inlet IN which is connected to the aerosol generator 5 in order to provide a starting material for generating the aerosol 7. The starting material inlet IN can, for example, be connected to an external source. Alternatively, a starting material container (not shown) is arranged in the housing 2 and is connected to the aerosol generator 5 in order to provide a starting material for generating the aerosol 7. For example, smoke, fog, tracer gas, etc., can be provided or generated as aerosol 7. During the leak detection using the leak testing device 1, a leak can be detected when the aerosol 7 escapes from the component 20 to be tested. Depending on the aerosol 7 used, various known methods can be used to detect the aerosol 7 that has escaped from component 20 (e.g. using a gas sniffer, optically with UV light, etc.).

The aerosol generator 5 is connected to the pneumatic unit 3 and to the aerosol outlet R of the housing 2. As shown in FIG. 2, the aerosol generator 5 comprises an aerosol generator inlet RE and an aerosol generator outlet RA. The pneumatic unit 3 is designed to direct the compressed medium into the aerosol generator 5 for leak detection. For this purpose, the pneumatic unit 3 is connected to the aerosol generator inlet RE via the pneumatic outlet KA. The medium with the first pressure flows into the aerosol generator 5 via the connection between the pneumatic unit 3 and the aerosol generator 5. The introduced medium conveys the aerosol 7 generated in the aerosol generator 5 into a component 20 to be tested, which is connected to the aerosol outlet R of the housing 2. In FIG. 2, the path of the medium during operation of the leak testing device 1 for leak detection is indicated by arrows. The aerosol generator outlet RA is connected to the aerosol outlet R of the housing 2. Alternatively, in a simple manner, the aerosol generator outlet RA can form the aerosol outlet R of the housing 2.

The control unit 4 is designed to control the pneumatic unit 3 and the aerosol generator 5 for leak detection. For example, the control unit 4 regulates a temperature of the heating coil of the aerosol generator 5. In addition to the pneumatic unit 3, the control unit 4 is also connected to the aerosol generator 5 via a suitable wired or wireless connection (not shown).

The component 20 to be tested is connected in FIG. 2, by way of example, to both the test outlet A1 and the aerosol outlet R. This means that the component 20 can first be checked for leak-tightness and then leak detection can be carried out (if necessary). Of course, the component 20 must be designed to be connected to both outlets A1, R.

The stored algorithm in the control unit 4 can be designed to execute an automated test program to check the leak-tightness of the connected components 20 with subsequent leak detection.

In FIG. 1, the aerosol generator 5 is directly connected to the pneumatic unit 3, wherein the medium is conveyed from the pneumatic unit 3 both to the test outlet A1 and to the aerosol generator 5. The leak testing device 1 may also comprise a switch unit 6 (as shown in FIG. 2), which is provided to switch the pneumatic unit 3 between the connected test outlet A and the connected aerosol generator 5 in order to direct the medium from the pneumatic unit 3 either to the test outlet A1 or to the aerosol generator 5. As shown by way of example in FIG. 2, the switch unit 6 is arranged downstream of the pneumatic outlet KA and is connected, on the one hand, to the test outlet A1, and on the other hand, to the aerosol generator inlet RE. The switch unit 6 is in the position in which the pneumatic outlet KA of the pneumatic unit 3 is connected to the aerosol generator inlet RE of the aerosol generator 5, thereby allowing leak detection to be performed. The control unit 4 is designed to control the switch unit 6 and is connected to the switch unit 6 via a suitable wired or wireless connection. In FIG. 2, a wired connection 10 (e.g. an electrical line) is shown as a dashed line.

Alternatively, the pneumatic unit 3 may have two pneumatic outlets KA1, KA2, wherein one of the two pneumatic outlets KA1 is connected to the test outlet A and the other of the two pneumatic outlets KA2 is connected to the aerosol generator 5. The switch unit 6 can be comprised in the pneumatic unit 3 and can be designed to switch between the two pneumatic outlets KA1, KA2 of the pneumatic unit 3.

An electrical power supply is provided to operate the leak testing device 1 and its components. For example, an electrical energy storage device (e.g. a battery) can be arranged in the housing 2 in order to supply the leak testing device 1 with electrical energy and/or the housing 2 has an electrical connection which is designed to connect an external energy source (e.g. power grid) to the leak testing device 1 in order to supply the leak testing device 1 with electrical energy.

The leak testing device 1 preferably has at least one safety valve 16 which is designed to regulate the compressed medium to a predetermined safety pressure. The safety valve 16 is designed to be opened in the event of a failure of the electrical power supply and to at least partially discharge the medium (e.g. with the first pressure) from the housing 2 in order to regulate it to the specified safety pressure. This can prevent an impermissibly high pressure in the housing 2. In FIG. 2, a safety valve 16 connected to the pneumatic unit 3 is shown by way of example, which, when triggered, releases the medium from the housing 2 (indicated by arrow). Preferably, one safety valve 16 is provided for each test outlet A1, A2. The at least one safety valve 16 can, for example, also be comprised in the pneumatic unit 3 (e.g. in the valve unit). As the safety valve 16, for example, a check valve, e.g. a controlled check valve, is provided.

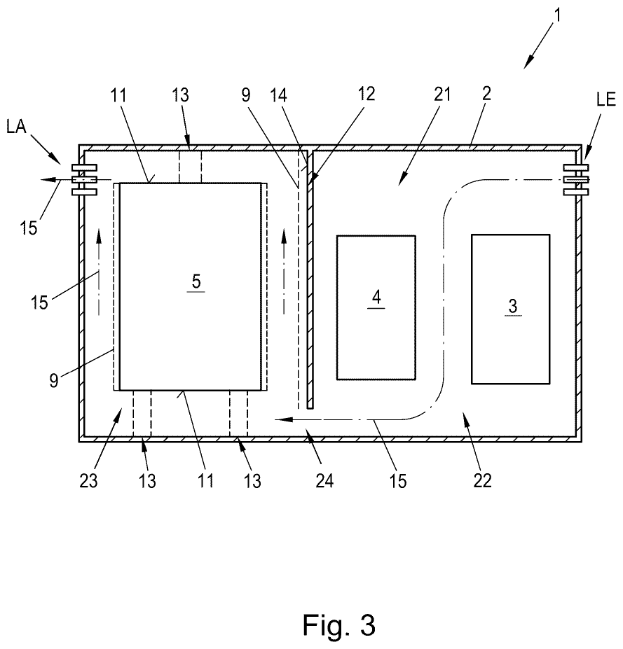

FIG. 3 shows a side sectional view of the leak testing device 1. The housing 2, the pneumatic unit 3, the control unit 4, and the aerosol generator 5 are only indicated schematically. The housing 2 preferably has an air inlet LE and an air outlet LA. The air inlet LE and the air outlet LA are designed so that, for example, ambient air can flow into the housing 2 through the air inlet LE and air in the housing 2 can flow out of the housing 2 through the air outlet LA. As shown in FIG. 3, the air inlet LE is arranged in the area of the pneumatic unit 3 and the control unit 4. The air outlet LA is preferably arranged in the area of the aerosol generator 5. Of course, depending on the embodiment, the housing 2 can also have a plurality of air inlets LE and/or air outlets LA.

During operation of the leak testing device 1, air heated by the generation of the aerosol 7 in the vicinity of the aerosol generator 5 (temperature of approximately 70° C.) is directed out of the housing 2 through the air outlet LA and ambient air (temperature below 40° C.) flows into the housing 2 through the air inlet LE. An air flow 15 is created through the housing 2. This enables passive cooling of the housing 2, in particular the inside of the housing 21, by convection. The air flow 15 removes the heated air and cools electrical and/or electronic components of the leak testing device 1, in particular the control unit 4, the at least one pressure sensor 8, the evaluation unit, etc. This protects the components from impermissible heat input generated by the generation of the aerosol 7. By cooling the housing 2, measurement errors of the at least one pressure sensor 8 can be avoided. For example, deviations (drift) in the measured values of the at least one pressure sensor 8 occur if it is heated to an inadmissible level. In FIG. 3, the air flow 15 is shown only by way of example by means of an arrow.

In the embodiment of the leak testing device 1 according to FIG. 3, convection takes place naturally. In addition, forced convection may also be provided, e.g. by means of a fan at the air inlet LE and/or air outlet LA. This enables active cooling of the housing 2. The heated air from the vicinity of the aerosol generator 5 is conveyed out of the housing 2 through the air outlet LA, and ambient air is conveyed into the housing 2 through the air inlet LE.

Alternatively or additionally, the aerosol generator 5 can be at least partially encased with a thermally insulating material 9. For example, ceramic, plastic, glass or rock wool, cellulose, hemp, etc., are used as the thermally insulating material 9. The thermally insulating material 9 has a lower thermal conductivity than the material that forms the aerosol generator 5, in particular the container for aerosol generation (e.g. aluminum or steel). As shown in FIG. 3 by way of example, the aerosol generator 5 is designed as a cylinder. Preferably, the thermally insulating material 9 is provided on the radial peripheral surface of the aerosol generator 5. As a result, the heat generated during operation of the aerosol generator 5 is directed to the end faces 11 of the aerosol generator 5, which have a higher thermal conductivity, due to the lower thermal conductivity of the thermally insulating material 9 on the radial peripheral surface. The resulting air flow 15 flows past the end faces 11 and removes the heat or the heated air there (convection), as shown in FIG. 3.

The housing 2 is preferably divided by a partition wall 12 into a pneumatic area 22 and an aerosol generator area 23. At least the pneumatic unit 3 is arranged in the pneumatic area 22 and the aerosol generator 5 is arranged in the aerosol generator area 23. As shown in FIG. 3, the control unit 4 is also arranged in the pneumatic area 22. For example, the pressure sensors 8 may also be arranged in the pneumatic area 22. The partition wall 12 allows the pneumatic area 22 to be insulated from the heat generated during operation of the aerosol generator 5. For this purpose, a side 14 of the partition wall 12 facing the aerosol generator 5 preferably also has a thermally insulating material 9. Said thermally insulating material may be identical to the thermally insulating material 9 that is used for at least partially encasing the aerosol generator 5.

In order to direct the air flow 15 in a targeted manner, the pneumatic area 22 can be connected to the aerosol generator area 23 via a channel 24. The channel 24 is provided, as shown by way of example in FIG. 3, in the partition wall 12 at the bottom of the housing 2. Radially around the aerosol generator 5, a kind of chimney forms in the aerosol generator area 23, forcing the air flow 15 to rise along the aerosol generator 5 (chimney effect, as shown in FIG. 3). The heated air in the aerosol generator area 23 rises due to its reduced density, and colder air with a higher density flows from the pneumatic area 22 through the channel 24 and displaces the heated air, causing it to be directed out of the air outlet LA.

In addition, inserts 13 made of thermally insulating material 9 can be provided between the aerosol generator 5 and the housing 2. The aerosol generator 5, in particular its peripheral surfaces, are spaced from the housing 2 by the inserts 13 in order to prevent heat transfer from the aerosol generator 5 to the housing 2 during operation of the leak testing device.

The connection between one of the test outlets A1, A2 can be designed as a predefined test volume in order to calibrate the leak testing device 1 during operation. For example, the connecting hose 25 is provided, which is connected to one of the test outlets A1, A2 of the housing and forms a defined test volume in order to calibrate the leak testing device 1 during operation. For example, the pressure drop in the known test volume of the connecting hose 25 is measured over a defined period of time. The connecting hose 25 can, for example, be designed as a fabric hose and can be connected to the respective test outlet A1, A2 by means of a quick-coupling connection. Designed as an external connecting hose 25, the service and maintenance thereof are easy to perform. Of course, the connecting hose 25 can also be arranged and connected inside the housing 21. This means that the connection of the connecting hose 25 is inaccessible outside the housing 2.

1. A leak testing device for checking components, in particular vehicle components, for leak-tightness and for leak detection, wherein the leak testing device comprises:
a housing which has at least one test inlet, at least one test outlet, and an aerosol outlet, wherein at least the following are arranged in the housing:
a pneumatic unit which is connected to the at least one test inlet and the at least one test outlet,
a control unit which is configured to control the pneumatic unit in order to change a pressure of a medium present at the at least one test inlet to a predetermined first pressure during operation of the leak testing device and to provide and monitor the medium with the first pressure at the test outlet for checking a component connected to the test outlet for leak-tightness, and
an aerosol generator which is configured to generate aerosol, wherein the aerosol generator is connected to the pneumatic unit and the aerosol generator is connected to the aerosol outlet, wherein, for leak detection, the pneumatic unit is configured to direct the medium with the first pressure into the aerosol generator in order to convey the aerosol generated in the aerosol generator into a component connected to the aerosol outlet of the housing.

2. The leak testing device according to claim 1, wherein the leak testing device comprises a switch unit, which is provided to connect the pneumatic unit to the aerosol generator or to the test outlet.

3. The leak testing device according to claim 1, wherein the first pressure is an underpressure or an overpressure.

4. The leak testing device according to claim 1, wherein the housing has a further test outlet which is connected to the pneumatic unit, wherein the pneumatic unit is configured to change the pressure of the medium present at the test inlet to a second pressure different from the predetermined first pressure and to provide the medium with the second pressure at the further test outlet.

5. The leak testing device according to claim 1, wherein the housing as an air inlet and an air outlet in order to direct air heated by the generation of the aerosol during operation of the leak testing device in the vicinity of the aerosol generator through the air outlet out of the housing and to direct ambient air through the air inlet into the housing, wherein a passive cooling of the housing takes place by convection.

6. The leak testing device according to claim 1, wherein the aerosol generator is at least partially encased with a thermally insulating material.

7. The leak testing device according to claim 1, wherein the housing is divided by a partition wall into a pneumatic area and an aerosol generator area, wherein the pneumatic unit is arranged in the pneumatic area and the aerosol generator is arranged in the aerosol generator area, and in that the pneumatic area is connected to the aerosol generator area via a channel, wherein a side of the partition wall facing the aerosol generator has a thermally insulating material.

8. The leak testing device according to claim 1, wherein the leak testing device has at least one safety valve which is configured to regulate the pressure of the medium to a predetermined safety pressure.

9. The leak testing device according to claim 1, wherein a connecting hose is provided, which is connected to one of the test outlets of the housing and defines a predetermined test volume in order to calibrate the leak testing device.

10. The leak testing device according to claim 1, wherein the housing further has a starting material inlet which is connected to the aerosol generator in order to provide a starting material for generating the aerosol, or a starting material container is arranged in the housing and is connected to the aerosol generator in order to provide a starting material for generating the aerosol.
